(19) United States
(12) Patent Application Publication
(10) Pub. No.: US 2012/0302718 A1
(43) Pub. Date: Nov. 29, 2012

(54) Polyisocyanate Polyaddition Products, Method for Producing Same, and Use Thereof

(75) Inventors: Jens Krause, Leverkusen (DE); Stephan Reiter, Langenfeld (DE); Hartmut Nefzger, Pulheim (DE)

(73) Assignee: Bayer Intellectual Property GmbH Creative Campus Monheim, Monheim (DE)

(21) Appl. No.: 13/576,581

(22) PCT Filed: Jan. 28, 2011
(86) PCT No.: PCT/EP2011/051243

§ 371 Date: Aug. 1, 2012

(30) Foreign Application Priority Data
Feb. 2, 2010 (DE) 10 2010 006 511.0

(51) Int. Cl. C08G 18/72; C08G 18/24; B01J 27/24

(52) U.S. Cl. 528/58; 502/200

(57) ABSTRACT

The invention relates to polyisocyanate polyaddition products, to a method for producing same, and to the use thereof.

Polyisocyanate polyaddition products, method for producing same, and use thereof The invention relates to polyisocyanate polyaddition products, to a process for preparation thereof and to the use thereof.

Polyurethanes have been known for a long time and are used in many sectors. Frequently, the actual polyurethane reaction has to be performed using catalysts, since the reaction otherwise proceeds too slowly and may lead to polyurethane products with poor mechanical properties. In most cases, the reaction between the hydroxyl component (NCO-reactive group, OH group) and the NCO component has to be catalyzed. The commonly used catalysts are divided into metallic and nonmetallic catalysts. Typical commonly used catalysts are, for example, amine catalysts, for instance 1,8-diazabicyclo[5.4.0]undec-7-ene (DBU), 1,4-diazabicyclo[2.2.2]octane (DABCO) or triethanolamine. Metallic catalysts are usually Lewis acid compounds, for instance dibutyltin dilaurate, lead octoate, tin octoate, titanium and zirconium complexes, but also cadmium compounds, bismuth compounds (for example bismuth neodecanoate) and iron compounds. One requirement on the catalyst is that it catalyzes only one of the various polyurethane reactions in a very well-defined manner, for instance only the reaction between OH and NCO groups. Side reactions, for example di- or trimerizations of the isocyanate, allophanatizations, biuretizations, water reactions or urea formations should not be catalyzed at the same time. The requirement is always to the effect that an optimal catalyst catalyzes exactly the reaction desired; for example, only the water reaction, so as to give rise to a defined foam profile or, as in the case of use of the potassium acetates, preferably the polyisocyanurate reaction. However, there are barely any catalysts to date which catalyze only one defined reaction. However, this is exceptionally desirable given the various possible reactions in polyurethane preparation. Catalysts of particular interest are not only those which catalyze only one reaction in a defined manner, but also catalysts which additionally become selectively active and catalyze reactions only under particular conditions. In such cases, reference is made to switchable catalysts. These switchable catalysts are in turn divided into thermally, photochemically, chemically (for example via dissociation) and optically switchable catalysts. In general, reference is also made in this context to latent catalysts and, in the thermal case, to thermolatent catalysts. These catalysts are inactive until the reaction mixture reaches a particular temperature. Above this temperature, they are then active, preferably abruptly active. These latent catalysts enable long pot lives and fast demolding times.

The latent catalysts known to date and used with preference are mercury compounds. The most prominent representative here is phenylmercuric neodecanoate (Thorcat® 535 and Cocure® 44). This catalyst reveals a latent reaction profile, the catalyst being virtually inactive at first and becoming abruptly active at a particular temperature (usually around 70° C.) only after gradual heating, usually due to the exothermicity of the uncatalyzed reaction of NCO with OH groups. When this catalyst is used, very long open times coupled with very short curing times can be achieved. This is advantageous particularly when a very large amount of material has to be discharged (for example a large mold has to be filled) and, on completion of discharge, the reaction is to be ended rapidly and thus economically.

It is particularly advantageous in the case of use of latent catalysts when the following conditions are additionally fulfilled:

a) An increase in the amount of catalyst accelerates the reaction without the catalyst losing latency.

a) A decrease in the amount of catalyst slows the reaction without the catalyst losing latency.

A variation in the amount of catalyst, in the index, in the mixing ratio, in the amount discharged and/or in the hard segment content in the polyurethane does not impair the latency of the catalyst.

d) In all aforementioned variations, the catalyst ensures virtually full conversion of the reactants without any tacky sites remaining.

A particular advantage of the latent catalysts is considered to be that, in finished polyurethane material, they accelerate the cleavage of urethane groups only slightly compared to conventional catalysts, for example at room temperature, due to the decrease in their catalytic action with falling temperature. They thus contribute to favorable long-term use properties of the polyurethanes.

Furthermore, in the case of use of catalysts, it should generally be ensured that the physical properties of the products are adversely affected to a minimum degree. This is also the reason why controlled catalysis of a particular reaction is so important. Specifically in the case of production of elastomers, especially of cast elastomers, the use of mercury catalysts is very widespread, since they are widely usable, need not be combined with additional catalysts and catalyze the reaction between OH and NCO groups in a very controlled manner. The only disadvantage—but a very important one—is the high toxicity of the mercury compounds, such that great efforts are being made to find alternatives to the mercury catalysts. Furthermore, these compounds are unwelcome in some industries (automotive and electrical industries).

Systems which are at least less toxic than mercury catalysts, for example based on tin, zinc, bismuth, titanium or zirconium, but also amidine and amine catalysts, are known on the market, but to date do not have the robustness and simplicity of the mercury compounds and are additionally not latent, or not latent enough.

WO 2008/018601 describes the use of catalysts based on blends of amines, cyclic nitrogen compounds, carboxylates and/or quaternary ammonium salts. Such blends, however, have the disadvantages known to those skilled in the art. While amines and cyclic nitrogen compounds have direct activating action and thus entail insufficient latency for particular applications, carboxylates and quaternary ammonium salts also catalyze, for example, the polyisocyanurate reaction, which must be absolutely prevented in particular applications, for example high-performance elastomers.

The effect of particular combinations of catalysts is that the gel reaction proceeds very substantially separately from the curing reaction, since many of these catalysts act only selectively. For example, bismuth(III) neodecanoate is combined with zinc neodecanoate and neodecanoic acid. Often, 1,8-diazabicyclo[5.4.0]undec-7-ene is additionally added. Even though this combination is one of the most well-known, it is unfortunately not as widely and universally usable as, for example, Thorcat® 535 (from Thor Especialidades S.A.) and is additionally susceptible in the event of variations in formulation. The use of these catalysts is described in DE-A 10 2004 011 348. Further combinations of catalysts are disclosed in U.S. Pat. No. 3,714,077, U.S. Pat. No. 4,584,362, U.S. Pat. No. 5,011,902, U.S. Pat. No. 5,902,835 and U.S. Pat. No. 6,590,057.

WO 2005/058996 describes the combination of titanium catalysts and zirconium catalysts with bismuth catalysts. A crucial disadvantage of the catalyst combinations described is, however, that they are not usable as widely and universally as the mercury catalysts and are susceptible in the event of variations in formulation.

The titanium catalysts described in WO 2008/155569 are also afflicted with some disadvantages compared to the mercury catalysts. For acceptable results, it is necessary to add an amine-based cocatalyst. This is a trimerization catalyst, which in particular applications (e.g. cast elastomers) has adverse effects on the physical properties of the polyurethanes. A variation in the mixing ratio of the catalyst components can achieve either very good latency or very good material properties, but not both at the same time. The catalyst combinations described consequently have to be matched to the particular requirements with regard to the mixing ratio thereof, which means that it is not possible with one catalyst combination to cover all applications, and this constitutes a crucial disadvantage.

The DABCO DC-2 product from Air Products Chemicals Europe B.V., which is available on the market, is a catalyst mixture of 1,4-diazabicyclo[2.2.2]octane (DABCO) and dibutyltin diacetate. The disadvantage of this mixture is that the amine has direct activating action. Alternative systems are, for example, POLYCAT® SA-1/10 (from Air Products Chemicals Europe B.V.). This comprises acid-blocked DABCO. Even though this system is thermolatent, such systems are not used due to their poor catalytic action in the course of curing; the elastomers produced in the presence of these systems remain tacky at the end of the reaction; this is also referred to as “starvation” of the reaction.

WO 2009/050115 describes photolatent catalysts, but these have several important disadvantages. Solid moldings are generally produced in nontransparent metal molds, as a result of which activation of the photolatent catalysts by an external radiation source is virtually impossible. Even in the case of a technical solution to this problem, a further, inherent disadvantage arises from the limited penetration depth of the electromagnetic radiation into the reaction mixture.

DE-A 10 2008 026 341 describes thermolatent catalysts based on N-heterocyclic carbenes, but these have some significant disadvantages. The preparation of the compounds is very complex and hence costly, which means that there is little economic interest in the use of the catalysts in most applications. Furthermore, the compounds in particular polyurethane systems also catalyze the polyisocyanurate reaction, which must be absolutely prevented in particular applications, for example high-performance elastomers.

DE-A 10 2008 021 980 describes thermolatent tin catalysts, but these have a significant disadvantage. In polyurethane reaction mixtures having less than a certain content of reactive NCO groups, the exothermicity of the uncatalyzed reaction of NCO groups with OH groups is insufficient for the full activation of the thermolatent catalysts. This is especially true of thin-wall moldings, for which the temperatures attained in the course of curing can only be relatively low due to the high surface to volume ratio.

It was therefore an object of the present invention to provide systems and catalysts with which it is possible to prepare polyisocyanate polyaddition products with good mechanical properties, and which at first give a significantly retarded reaction and, after this initial phase, an accelerated reaction to give the end product. The system and the catalyst should additionally be free of toxic heavy metals, such as cadmium, mercury and lead. In addition, the mechanical properties of the polyisocyanate polyaddition products should at least be at the level of those obtained with the mercury catalysts.

This object is surprisingly achieved by the combination of two blocked amine and/or amidine catalysts switchable at different temperatures [for example blocked 1,8-diazabicyclo[5.4.0]undec-7-ene (DBU), 1,4-diazabicyclo[2.2.2]octane (DABCO), 1,5-diazabicyclo[4.3.0]non-5-ene (DBN)] in combination with a metal catalyst.

The switching temperature of a catalyst is considered by the catalyst manufacturers to be one of the important product properties (TEDA & TOYOCAT TECHNICAL DATA No. EE-003 (Issue Date 09-02-2004)). For example, Tosoh Corporation determines this switching temperature with the aid of differential thermal analysis (DSC), by heating a reaction mixture comprising the catalyst at a heating rate of 5° C./min within the temperature range from 30° C. to 250° C. The temperature at which the maximum exothermicity occurs is generally reported as the switching temperature (deblocking temperature). The onset temperature is the temperature at which the exothermic reaction sets in (commencement of exothermicity).

The invention provides polyisocyanate polyaddition products with good mechanical properties, obtainable from

a) polyisocyanates and

b) NCO-reactive compounds from the group of b1) long-chain polyols having an OH number of 27 to 112 mg KOH/g and a functionality of 1.9 to 2.3 and b2) short-chain hydroxyl compounds having an OH number of 300 to 1810 mg KOH/g and a functionality of 1.9 to 2.3, in the presence of

c) latent catalysts

d) optionally further catalysts other than c) and/or activators with addition of

e) optionally fillers and/or fiber materials

f) optionally assistants and/or additives,

g) optionally blowing agents, characterized in that the latent catalysts (c) used are mixtures of at least one metal catalyst from the group consisting of tin, titanium, zirconium, hafnium, bismuth, zinc, aluminum and iron catalysts and at least two blocked amines and/or amidines which switch at different temperatures, the onset temperature of one amine and/or amidine which switches at low switching temperature (T_{A}) being between 30° and 60° C. and the switching temperature of the other amine and/or amidine which switches at higher switching temperature (T.) being between 80° C. and 150° C. and the difference between T_{A} and T. being at least 20° C. and at most 100° C., preferably at least 30° C. and at most 80° C., more preferably at least 40° C. and at most 70° C.

The amine or amidine which switches at low temperature may also be a mixture of several amines and/or amidines, each of which have an onset temperature (T_{A}) between 30° C. and 60° C. The amine or amidine which switches at higher temperature may also be a mixture of several amines and/or amidines, each of which have a switching temperature (Tₘₐₓ) between 80° C. and 150° C.

The switching temperature is defined in TEDA & TOYOCAT TECHNICAL DATA No. EE-003 (Issue Date 09-02-2004). The switching temperature is the temperature at which the maximum exothermicity occurs, also referred to as deblocking temperature. The onset temperature is defined as the temperature at which the exothermic reaction sets in. The exothermicity is determined with the aid of differential thermal analysis (DSC), by heating a reaction mixture comprising the catalyst at a heating rate of 5° C./min within the temperature range from 30° C. to 250° C.

The metal catalysts used are preferably tin catalysts, more preferably organotin mercaptides, most preferably organotin(IV) dimercaptides.

Among the blocked amines, particular preference is given to salts and complexes of DBN, of DBU and/or of DABCO.

The NCO-reactive compounds b1) (long-chain polyols) are preferably polyester polyols, more preferably polyester polyols having OH numbers of 27 to 112 mg KOH/g, very especially preferably of 40 to 80 mg KOH/g, even more preferably of 50 to 70 mg KOH/g.

The functionalities are preferably in the range from 1.9 to 2.3, more preferably in the range from 1.95 to 2.2, very especially preferably in the range from 2.0 to 2.15 and especially preferably in the range from 2.02 to 2.09.

The short-chain, NCO-reactive hydroxyl compounds b2) are preferably short-chain diols, for example 1,2-ethanediol, 1,2-propanediol, 1,3-propanediol, 1,3-butanediol, 1,4-butanediol, 2,3-butanediol, 1,5-pentanediol, 1,6-hexanediol, HQEE (hydroquinone di(β-hydroxyethyl) ether), HER (resorcinol di(β-hydroxyethyl) ether) and/or triols (e.g. glycerol, trimethylolpropane) and/or tetraols (e.g. pentaerythritol). The short-chain hydroxyl compounds b2) used are more preferably the short-chain diols, for example 1,2-ethanediol, 1,2-propanediol, 1,3-propanediol, 1,4-butanediol, 1,5-pentanediol, 1,6-hexanediol; very particular preference is given to 1,4-butanediol.

The polyisocyanates (a) are preferably NCO prepolymers formed from diphenylmethane diisocyanate (MDI) and/or carbodiimidized/uretoniminized diphenylmethane diisocyanate and/or allophanatized MDI. The content of the carbodiimidized/uretoniminized diphenylmethane diisocyanate and/or allophanatized MDI in the prepolymer is preferably in the range from 0.02 to 6.5% by weight, more preferably in the range from 0.4 to 5% by weight and most preferably in the range from 0.7 to 2.5% by weight. The 4,4′ isomer of MDI is preferably present in proportions of 80 to 100% by weight, more preferably of 95 to 100% by weight. Preference is given to NCO prepolymers based on polyester polyols, more preferably based on polyadipate polyols, most preferably based on poly(butylene-co-ethylene adipate)polyols. The NCO contents are preferably in the range from 12 to 22% by weight, more preferably in the range from 14 to 20% by weight and most preferably in the range from 15 to 17% by weight.

The ratio of NCO-reactive groups to NCO groups is preferably in the range from 0.9 to 1.25, more preferably in the range from 0.92 to 1.00 and most preferably in the range from 0.94 to 0.98.

The assistants and additives (f) used are preferably zeolites, which are preferably introduced via the NCO-reactive compounds (b).

The hardness of the polyisocyanate polyaddition products is preferably in the range from 50 to 96 Shore A, more preferably in the range from 60 to 96 Shore A and most preferably in the range from 60 to 85 Shore A.

The invention further provides a process for preparing the inventive polyisocyanate polyaddition products, by reacting polyisocyanates (a) with NCO-reactive compounds (b) in the presence of latent catalysts (c) and optionally additional catalysts other than (c) and/or activators (d), with addition of optionally blowing agents (g), optionally fillers and/or fiber materials (e) and optionally assistants and/or additives (f), characterized in that the latent catalysts (c) used are mixtures of at least one metal catalyst from the group consisting of tin, titanium, zirconium, hafnium, bismuth, zinc, aluminum and iron catalysts and at least two blocked amines and/or amidines which switch at different temperatures, the onset temperature of one amine and/or amidine which switches at low switching temperature (T_{A}) being between 30° and 60° C. and the switching temperature of the other amine and/or amidine which switches at higher switching temperature (Tₘₐₓ) being between 80° C. and 150° C. and the difference between T_{A} and Tₘₐₓ being at least 20° C. and at most 100° C., preferably at least 30° C. and at most 80° C., more preferably at least 40° C. and at most 70° C.

The metal catalysts used are preferably tin catalysts, more preferably organotin mercaptides, most preferably organotin(IV) dimercaptides.

Among the blocked amines, particular preference is given to salts and complexes of DBN, of DBU and/or of DABCO.

The blocked amine/amidine Toyocat® DB 30 exhibits exothermicity between 32° C. (onset of exothermicity) and 57° C. (maximum exothermicity). Correspondingly, values of 36 and 69° C. are found for Toyocat® DB 41, of 61 and 127° C. for DB 60, and of 125 and 143° C. for DB 70. In the case of unblocked catalysts such as Dabco 33 LV, these values are 35 and 48° C., and for DBTL 33 and 54° C. For the comparative catalyst Thorcat® 535, 37 and 94° C. were determined.

The NCO-reactive compounds b1) are preferably polyester polyols, more preferably polyester polyols having OH numbers of 27 to 112 mg KOH/g, very especially preferably of 40 to 80 mg KOH/g, even more preferably of 50 to 70 mg KOH/g. The functionalities are preferably in the range from 1.9 to 2.3, more preferably in the range from 1.95 to 2.2, very especially preferably in the range from 2.0 to 2.15 and even more preferably in the range from 2.02 to 2.09.

The short-chain, NCO-reactive hydroxyl compounds b2) are preferably short-chain diols, for instance 1,2-ethanediol, 1,2-propanediol, 1,3-propanediol, 1,3-butanediol, 1,4-butanediol, 2,3-butanediol, 1,5-pentanediol, 1,6-hexanediol, HQEE (hydroquinone hydroxyethyl) ether), HER (resorcinol di(β-hydroxyethyl) ether) and/or triols (e.g. glycerol, trimethylolpropane) and/or tetraols (e.g. pentaerythritol). Particularly preferred short-chain hydroxyl compounds b2) are the short-chain diols, for example 1,2-ethanediol, 1,2-propanediol, 1,3-propanediol, 1,4-butanediol, 1,5-pentanediol, 1,6-hexanediol; very particular preference is given to 1,4-butanediol.

The polyisocyanates (a) are preferably NCO prepolymers formed from diphenylmethane diisocyanate (MDI) and carbodiimidized/uretoniminized diphenylmethane diisocyanate and/or allophanatized MDI. The content of the carbodiimidized/uretoniminized diphenylmethane diisocyanate and/or allophanatized MDI in the prepolymer is especially preferably in the range from 0.02 to 6.5% by weight, very especially preferably in the range from 0.4 to 5% by weight and even more preferably in the range from 0.7 to 2.5% by weight. The 4,4′ isomer of MDI is preferably present in proportions of 80 to 100% by weight, more preferably of 95 to 100% by weight. Preference is given to prepolymers based on polyester polyols, more preferably based on polyadipate polyols, most preferably based on poly(butylene-co-ethylene adipate)polyols. The NCO contents are preferably in the range from 12 to 22% by weight, more preferably in the range from 14 to 20% by weight and most preferably in the range from 15 to 17% by weight.

The ratio of NCO-reactive groups to NCO groups is preferably in the range from 0.9 to 1.25, more preferably in the range from 0.92 to 1.00 and most preferably in the range from 0.94 to 0.98.

Preferred assistants and additives (f) are zeolites, introduced into the NCO-reactive compounds (b).

The hardness of the polyisocyanate polyaddition products is preferably in the range from 50 to 96 Shore A, more preferably in the range from 60 to 96 Shore A, most preferably in the range from 60 to 85 Shore A.

In a preferred process variant, the blocked amines and/or amidines are added via the NCO-reactive compounds b) and the metal catalyst separately, for example via the mixing head.

In a particularly preferred variant, the blocked amines and/or amidines and the metal catalyst are added via the NCO-reactive compounds b). In a very particularly preferred variant, the blocked amines and/or amidines and a portion of the metal catalyst are added via the NCO-reactive compounds b) and the rest of the metal catalyst via the mixing head. Also conceivable is metered addition via the isocyanate component.

The invention further provides latent catalysts consisting of a mixture of at least one metal catalyst from the group consisting of tin, titanium, zirconium, hafnium, bismuth, zinc, aluminum and iron catalysts and at least two blocked amines and/or amidines which switch at different temperatures, the onset temperature of one amine and/or amidine which switches at low switching temperature (T_{A}) being between 30° and 60° C. and the switching temperature of the other amine and/or amidine which switches at higher switching temperature (Tₘₐₓ) being between 80° C. and 150° C. and the difference between T_{A} and Tₘₐₓ being at least 20° C. and at most 100° C., preferably at least 30° C. and at most 80° C., more preferably at least 40° C. and at most 70° C.

The invention further provides for the use of the inventive latent catalysts for preparation of polyisocyanate polyaddition products, preferably polyurethane cast elastomers, more preferably solid polyurethane cast elastomers.

The solid polyurethane cast elastomers are preferably used for the production of screens, pipeline pigs, rolls, wheels, rollers, strippers, plates, cyclones, conveyor belts, coating bars, couplings, seals, buoys and pumps. They preferably have hardnesses in the range from 50 to 96 Shore A, more preferably in the range from 60 to 96 Shore A and most preferably in the range from 60 to 85 Shore A.

The invention further provides for the use of the inventive polyisocyanate polyaddition products for production of screens, pipeline pigs, rolls, wheels, rollers, strippers, plates, cyclones, conveyor belts, coating bars, couplings, seals, buoys and pumps.

The polyisocyanates (a) suitable for the preparation of polyisocyanate polyaddition compounds, especially polyurethanes, are the organic aliphatic, cycloaliphatic, aromatic or heterocyclic polyisocyanates having at least two isocyanate groups per molecule, which are known per se to those skilled in the art, and mixtures thereof. Examples of suitable aliphatic and cycloaliphatic polyisocyanates are di- or triisocyanates, for example butane diisocyanate, pentane diisocyanate, hexane diisocyanate (hexamethylene diisocyanate, HDI), 4-isocyanatomethyl-1,8-octane diisocyanate (triisocyanatononane, TIN) and cyclic systems, for example 4,4′-methylenebis(cyclohexyl isocyanate), 3,5,5-trimethyl-1-isocyanato-3-isocyanatomethylcyclohexane (isophorone diisocyanate, IPDI), and ω,ω′-d-diisocyanato-1,3-dimethylcyclohexane (H₆XDI). The aromatic polyisocyanates used may, for example, be naphthalene 1,5-diisocyanate, diisocyanatodiphenylmethane (2,2′-, 2,4′-and 4,4′-MDI or mixtures thereof), diisocyanatomethylbenzene (tolylene 2,4- and 2,6-diisocyanate, TDI) and technical-grade mixtures of the two isomers, and 1,3-bis(isocyanatomethyl)benzene (XDI). In addition, it is possible to use TODI (3,3′-dimethyl-4,4′-biphenyl diisocyanate), PPDI (1,4-paraphenylene diisocyanate) and CHDI (cyclohexyl diisocyanate).

Moreover, it is also possible to use the conversion products, known per se, of the aforementioned organic aliphatic, cycloaliphatic, aromatic or heterocyclic polyisocyanates with carbodiimide, uretonimine, uretdione, allophanate, biuret and/or isocyanurate structure, and prepolymers which are obtained by reaction of the polyisocyanate with compounds having groups reactive toward isocyanate groups.

The polyisocyanate component (a) may be present in a suitable solvent. Suitable solvents are those which have sufficient solubility for the polyisocyanate component and are free of groups reactive toward isocyanates. Examples of such solvents are acetone, methyl ethyl ketone, cyclohexanone, methyl isobutyl ketone, methyl isoamyl ketone, diisobutyl ketone, ethyl acetate, n-butyl acetate, ethylene glycol diacetate, butyrolactone, diethyl carbonate, propylene carbonate, ethylene carbonate, N,N-dimethylformamide, N,N-dimethylacetamide, N-methylpyrrolidone, N-ethylpyrrolidone, methylal, ethylal, butylal, 1,3-dioxolane, glycerol formal, benzene, toluene, n-hexane, cyclohexane, Solvent naphtha, 2-methoxypropyl acetate (MPA).

The isocyanate component may additionally comprise customary assistants and additives, for example rheology improves (for example ethylene carbonate, propylene carbonate, dibasic esters, citric esters), stabilizers (for example Brønsted and Lewis acids, for instance hydrochloric acid, phosphoric acid, benzoyl chloride, organo mineral acids such as dibutyl phosphate, and also adipic acid, malic acid, succinic acid, pyruvic acid or citric acid), UV stabilizers (for example 2,6-dibutyl-4-methylphenol), hydrolysis stabilizers (for example sterically hindered carbodiimides), emulsifiers, dyes which may be incorporable into the polyurethane to be formed at a later stage (which thus possess Zerevitinov-active hydrogen atoms) and/or color pigments.

The NCO-reactive compounds (b) used may be all compounds which are known to those skilled in the art and have a mean OH functionality of at least 1.5. These may be, for example, low molecular weight polyols b2), for example diols (e.g. 1,2-ethanediol, 1,3- or 1,2-propanediol, 1,4-butanediol), triols (e.g. glycerol, trimethylolpropane) and tetraols (e.g. pentaerythritol), but also higher molecular weight polyhydroxyl compounds b1) such as polyether polyols, polyester polyols, polycarbonate polyols, polysiloxane polyols and polybutadiene polyols.

Polyether polyols are obtainable in a manner known per se, by alkoxylation of suitable starter molecules under base catalysis or using double metal cyanide compounds (DMC compounds). Suitable starter molecules for the preparation of polyether polyols are, for example, simple low molecular weight polyols, water, organic polyamines having at least two N-H bonds, or any desired mixtures of such starter molecules. Preferred starter molecules for preparation of polyether polyols by alkoxylation, especially by the DMC process, are especially simple polyols such as ethylene glycol, propylene 1,3-glycol and butane-1,4-diol, hexane-1,6-diol, neopentyl glycol, 2-ethylhexane-1,3-diol, glycerol, trimethylolpropane, pentaerythritol, and low molecular weight hydroxyl-containing esters of such polyols with dicarboxylic acids of the type specified hereinafter by way of example, or low molecular weight ethoxylation or propoxylation products of such simple polyols, or any desired mixtures of such modified or unmodified alcohols. Alkylene oxides suitable for the alkoxylation are especially ethylene oxide and/or propylene oxide, which can be used in the alkoxylation in any sequence or else in a mixture.

Polyester polyols can be prepared in a known manner by polycondensation of low molecular weight polycarboxylic acid derivatives, for example succinic acid, glutaric acid, adipic acid, suberic acid, azelaic acid, sebacic acid, dodecanedioic acid, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, dimer fatty acid, trimer fatty acid, phthalic acid, phthalic anhydride, isophthalic acid, terephthalic acid, citric acid or trimellitic acid, with low molecular weight polyols, for example ethylene glycol, diethylene glycol, neopentyl glycol, hexanediol, butanediol, propylene glycol, glycerol, trimethylolpropane, 1,4-hydroxymethylcyclohexane, 2-methyl-1,3-propanediol, butane-1,2,4-triol, triethylene glycol, tetraethylene glycol, polyethylene glycol, dipropylene glycol, polypropylene glycol, dibutylene glycol and polybutylene glycol, or by ring-opening polymerization of cyclic carboxylic esters such as E-caprolacetone. In addition, it is also possible to polycondense hydroxycarboxylic acid derivatives, for example lactic acid, cinnamic acid or co-hydroxycaproic acid to give polyester polyols. However, it is also possible to use polyester polyols of oleochemical origin. Such polyester polyols can be prepared, for example, by full ring-opening of epoxidized triglycerides of an at least partly olefinically unsaturated fatty acid-containing fat mixture with one or more alcohols having 1 to 12 carbon atoms and subsequent partial transesterification of the triglyceride derivatives to alkyl ester polyols having 1 to 12 carbon atoms in the alkyl radical.

The preparation of suitable polyacrylate polyols is known per se to those skilled in the art. They are obtained by free-radical polymerization of olefinically unsaturated monomers having hydroxyl groups or by free-radical copolymerization of olefinically unsaturated monomers having hydroxyl groups with optionally different olefinically unsaturated monomers, for example ethyl acrylate, butyl acrylate, 2-ethylhexyl acrylate, isobornyl acrylate, methyl methacrylate, ethyl methacrylate, butyl methacrylate, cyclohexyl methacrylate, isobornyl methacrylate, styrene, acrylic acid, acrylonitrile and/or methacrylonitrile. Suitable olefinically unsaturated monomers having hydroxyl groups are especially 2-hydroxyethyl acrylate, 2-hydroxyethyl methacrylate, the hydroxylpropyl acrylate isomer mixture obtainable by addition of propylene oxide onto acrylic acid, and the hydroxypropyl methacrylate isomer mixture obtainable by addition of propylene oxide onto methacrylic acid. Suitable free-radical initiators are those from the group of the azo compounds, for example azoisobutyronitrile (AlBN), or from the group of the peroxides, for example di-tert-butyl peroxide.

Component (b1) may be present in a suitable solvent. Suitable solvents are those which have sufficient solubility for the component. Examples of such solvents are acetone, methyl ethyl ketone, cyclohexanone, methyl isobutyl ketone, methyl isoamyl ketone, diisobutyl ketone, ethyl acetate, n-butyl acetate, ethylene glycol diacetate, butyrolactone, diethyl carbonate, propylene carbonate, ethylene carbonate, N,N-dimethylformamide, N,N-dimethylacetamide, N-methylpyrrolidone, N-ethylpyrrolidone, methylal, ethylal, butylal, 1,3-dioxolane, glycerol formal, benzene, toluene, n-hexane, cyclohexane, Solvent naphtha, 2-methoxypropyl acetate (MPA). In addition, the solvents may also bear groups reactive toward isocyanates. Examples of such reactive solvents are those which have a mean functionality of groups reactive toward isocyanates of at least 1.8. These may also be, for example, the low molecular weight polyols b2), for example the diols (e.g. 1,2-ethanediol, 1,3- or 1,2-propanediol, 1,4-butanediol) and/or triols (e.g. glycerol, trimethylolpropane).

The starting compounds used for the catalysts used in accordance with the invention may, for example, be the amines and/or amidines sold by Tosoh Corporation: Toyocat®-DT, Toyocat®-MR, TEDA-L33, Toyocat®-NP, DBU. In addition, it is possible to use DBN and further tertiary amines or amidines. These can be blocked, for example, with acid, for example 2-ethylhexanoic acid, formic acid, acetic acid, methacrylic acid, trifluoroacetic acid, benzoic acid, cyanoacetic acid, 5-hydroxyisophthalic acid, phenol, catechol, methyl salicylate, o-hydroxyacetophenone, and hence converted to the catalysts used in accordance with the invention.

Typical latent, blocked amine and amidine catalysts usable are, for example, catalysts from the manufacturers Air Products (for example Polycat® SA-1/10, Dabco KTM 60) and

Tosoh Corporation (for instance Toyocat® DB 2, DB 30, DB 31, DB 40, DB 41, DB 42, DB 60, DB 70).

Useful typical metal catalysts include, for example, salts and organo compounds of the elements zirconium, titanium, tin, copper, lead, bismuth, zinc.

The process for preparing the polyisocyanate polyaddition products can be performed in the presence of customary rheology improvers, stabilizers, UV stabilizers, catalysts, hydrolysis stabilizers, emulsifiers, fillers, optionally incorporable dyes (which thus possess Zerevitinov-active hydrogen atoms) and/or color pigments. Preference is also given to an addition of zeolites.

Preferred assistants and additives are fillers, for example chalk, carbon black, flame retardants, color pastes, microbicides, flow improvers, thixotropic agents, surface modifiers, silicone oils, degassing aids and retardants in the case of production of the polyisocyanate polyaddition products, most preferably zeolites. An overview can be found in G. Oertel, Polyurethane Handbook, 2^{nd} edition, Carl Hanser Verlag, Munich, 1994, ch. 3.4.

The latent catalysts can be used for production of polyisocyanate polyaddition products, especially polyurethane elastomers such as coatings, adhesives and sealants, cast elastomers, resins and binders. Preferably, the inventive latent catalysts can be used for production of polyurethane cast elastomers, more preferably for production of solid polyurethane cast elastomers.

The invention is to be illustrated hereinafter by the examples which follow.

### EXAMPLES

Raw materials used:

1.) MDQ 23165: MDI prepolymer from Baulé S.A.S., formed from poly(ethylene-co-butylene) adipate of hydroxyl number 56 mg KOH/g, Desmodur® 44M and Desmodur CD-S with a proportion of carbodiimidized/uretoniminized MDI of approx. 2% by weight and an NCO content of 16.4% by weight.

2.) Desmodur 44M: polyisocyanate from Bayer MaterialScience AG with an NCO content of approx. 33.5% by weight.

3.) Desmodur® CD-S: polyisocyanate (carbodiimidized/uretoniminized diphenylmethane diisocyanate based on the 4,4′ isomer) from Bayer MaterialScience AG with an NCO content of approx. 29.5% by weight and a proportion of carbodiimidized/uretoniminized MDI of approx. 23.5% by weight.

4.) Baytec® D20: polyadipate polyol from Bayer MaterialScience with a hydroxyl number of 60 mg KOH/g and a functionality of 2.08.

5.) 1,4-butanediol: from BASF

6.) Polycat® SA-1/10: switchable amine from Air Products, which according to the manufacturer is switchable/latent at 80° C.

7.) Dabco KTM 60: switchable amine from Air Products, which according to the manufacturer is switchable/latent at 60° C.

8.) TIB KAT 214 (dioctyltin dimercaptide) from TIB Chemicals AG, Mannheim.

9.) Thorcat® 535 (80% phenyl-Hg neodecanoate, 20% neodecanoic acid); from Thor Especialidades S.A.)

10.) UOP L paste from UOP.

11.) Polyol 1: mixture of 98.002 parts Baytec® D20, 1.96 parts UOP L paste, 0.01 part Polycat® SA 1/10 and 0.028 part Dabco KTM 60.

Instruments and analytical methods used:

Hydroxyl number: based on standard DIN 53240% by weight of NCO: based on standard DIN 53185

### Example 1

### Production of a Cast Elastomer with a Shore A Hardness of 60

100 parts by weight of MDQ 23165 (preheated to 45° C.) mixed with 180 parts by weight of polyol 1 (preheated to 60° C.), 9.1 parts by weight of 1,4-butanediol (preheated to 45° C.) and 0.0005% by weight (based on overall formulation) of TIB KAT 214 and poured into a mold preheated to 80° C. Demolding was effected after about 30 min and the moldings were subjected to further heat treatment in a heating cabinet at 80° C. for 16 hours. The properties were determined at room temperature after 1 week of storage. The Shore A hardness was found to be 60. This hardness is typical of soft screen linings. For further mechanical properties see table 1.

### Example 2

### Production of a Cast Elastomer with a Shore A hardness of 85

100 parts by weight of MDQ 23165 (preheated to 45° C.) mixed with 80 parts by weight of polyol 1 (preheated to 60° C.), 13.6 parts by weight of 1,4-butanediol (preheated to 45° C.) and 0.0005% by weight (based on overall formulation) of TIB KAT 214 and poured into a mold preheated to 80° C. Demolding was effected after about 30 min and the moldings were subjected to further heat treatment in a heating cabinet at 80° C. for 16 hours. The properties were determined at room temperature after 1 week of storage. The Shore A hardness was found to be 85. This hardness is typical of hard screen linings and pig disks. For further mechanical properties see table 1.

### Example 3

### Production of a Cast Elastomer with a Shore A Hardness of 95

100 parts by weight of MDQ 23165 (preheated to 45° C.) mixed with 40 parts by weight of polyol 1 (preheated to 60° C.), 15.4 parts by weight of 1,4-butanediol (preheated to 45° C.) and 0.0005% by weight (based on overall formulation) of TIB KAT 214 and poured into a mold preheated to 80° C. Demolding was effected after about 30 min and the moldings were subjected to further heat treatment in a heating cabinet at 80° C. for 16 hours. The properties were determined at room temperature after 1 week of storage. The Shore A hardness was found to be 95. This hardness is typical of hard elastic elastomers, for instance in the case of hydrocyclones and seals. For further mechanical properties see table 1.

### Examples 4 to 16 were executed analogously to the above examples.

TABLE 1

| | | | | Inventive examples | | | Comparative examples | | |
|---|---|---|---|---|---|---|---|---|---|
| | | | | Ex. 1 | Ex. 2 | Ex. 3 | Ex. 4 | Ex. 5 | Ex. 6 |
| Formulation | Prepolymer | MDQ 23165 | [parts by wt.] | 100 | 100 | 100 | 100 | 100 | 100 |
| and | Polyol mixture | polyol 1 | [parts by wt.] | 180 | 80 | 40 | 180 | 80 | 40 |
| processing | | butane-1,4-diol | [parts by wt.] | 9.1 | 13.6 | 15.4 | 9.1 | 13.6 | 15.4 |
| | Catalysts | TIB KAT 214 | [% by wt. based on overall | 0.0005 | 0.0005 | 0.0005 | | | |
| | | | reaction mixture] | | | | | | |
| | | Thorcat 535 | [% by wt. based on overall | | | | 0.1 | 0.1 | 0.1 |
| | | | reaction mixture] | | | | | | |
| | Casting time | | [min] | 4.5 | 3.5 | 2 | 4 | 3 | 2 |
| Mechanical | Hardness (−5° C.) | DIN 53505 | [Shore A] | 63 | 89 | 97 | 62 | 87 | 96 |
| properties | Hardness (+20° C.) | DIN 53505 | [Shore A] | 60 | 85 | 95 | 60 | 85 | 95 |
| | Hardness (+80° C.) | DIN 53505 | [Shore A] | 57 | 83 | 94 | 58 | 82 | 92 |
| | 10% modulus | DIN 53504 | [MPa] | 0.9 | 2.9 | 6.4 | 0.7 | 2.5 | 6.5 |
| | 100% modulus | DIN 53504 | [MPa] | 2.5 | 7 | 11.9 | 2.4 | 7.3 | 13.6 |
| | 200% modulus | DIN 53504 | [MPa] | 3.4 | 9.6 | 15 | 3.3 | 10.1 | 17.8 |
| | 300% modulus | DIN 53504 | [MPa] | 4.6 | 12.6 | 19.3 | 4.6 | 13.8 | 23.5 |
| | Tensile stress at break | DIN 53504 | [MPa] | 34 | 47 | 45 | 26 | 38 | 38 |
| | Elongation at break | DIN 53504 | [%] | 590 | 705 | 610 | 545 | 535 | 515 |
| | Tear propagation | DIN 53515 | [kN/m] | 52 | 112 | 162 | 52 | 110 | 150 |
| | resistance: without notch | | | | | | | | |
| | Tear propagation | DIN 53515 | [kN/m] | 22 | 52 | 92 | 31 | 48 | 89 |
| | resistance: notched | | | | | | | | |
| | Rebound resilience | DIN 53512 | [%] | 49 | 38 | 33 | 47 | 43 | 37 |
| | Abrasion loss | DIN 53516 | [mm³] | 35 | 40 | 50 | 35 | 45 | 60 |
| | Compression set | DIN 53517 | [%] | 16 | 22 | 24 | 12 | 19 | 26 |
| | Specific density | | [g/mm³] | 1.24 | 1.24 | 1.24 | 1.21 | 1.21 | 1.21 |

The demolding time in all examples was about 30 min.

TABLE 2

| | | | | Comparative examples | | | | | | | | | |
|---|---|---|---|---|---|---|---|---|---|---|---|---|---|
| | | | | Ex. 7 | Ex. 8 | Ex. 9 | Ex. 10 | Ex. 11 | Ex. 12 | Ex. 13 | Ex. 14 | Ex. 15 | Ex. 16 |
| Formula- | Pre- | MDQ | [parts by | 100 | 100 | 100 | 100 | 100 | 100 | 100 | 100 | 100 | 100 |
| tion and | polymer | 23165 | wt.] | | | | | | | | | | |
| processing | Polyol | Baytec ® | [parts by | 40 | 40 | 180 | 40 | 180 | 40 | 180 | 40 | 180 | 40 |
| | mixture | D20 | wt.] | | | | | | | | | | |
| | | butane-1,4- | [parts by | 15.4 | 15.4 | 9.1 | 15.4 | 9.1 | 15.4 | 9.1 | 15.4 | 9.1 | 15.4 |
| | | diol | wt.] | | | | | | | | | | |
| | Catalysts | TIB KAT | [% by wt. | | | | | | | 0.0005 | 0.0005 | 0.0005 | 0.0005 |
| | | 214 | based on | | | | | | | | | | |
| | | | overall | | | | | | | | | | |
| | | | reaction | | | | | | | | | | |
| | | | mixture] | | | | | | | | | | |
| | | Polycat ® | [% by wt. | 0.2 | | 0.01 | 0.01 | 0.01 | 0.01 | 0.2 | 0.2 | | |
| | | SA1/10 | based on | | | | | | | | | | |
| | | | Baytec ® | | | | | | | | | | |
| | | | D20] | | | | | | | | | | |
| | | Dabco | [% by wt. | | 0.6 | 0.028 | 0.028 | 0.028 | 0.028 | | | 0.6 | 0.6 |
| | | KTM60 | based on | | | | | | | | | | |
| | | | Baytec ® | | | | | | | | | | |
| | | | D20] | | | | | | | | | | |
| | | Thorcat ® | [% by wt. | | | | | | | | | | |
| | | 535 | based on | | | | | | | | | | |
| | | | overall | | | | | | | | | | |
| | | | reaction | | | | | | | | | | |
| | | | mixture | | | | | | | | | | |
| | | | formula- | | | | | | | | | | |
| | | | tion] | | | | | | | | | | |
| | Additive | Baylith ® | [% by wt. | | | | | 2 | 2 | | | | |
| | | L paste | based on | | | | | | | | | | |
| | | | Baytec ® | | | | | | | | | | |
| | | | D20] | | | | | | | | | | |
| | Casting | | [min] | 2 | 2 | 4 | 2 | 4 | 2 | 4 | 2 | 4 | 2 |
| | time | | | | | | | | | | | | |
| | Remarks: | | | 7 | 8 | 9 | 10 | 11 | 12 | 13 | 14 | 15 | 16 |

In order to conduct meaningful comparisons with the Thorcat 535-catalyzed cast elastomers (see table 1, exs. 4-6), the amounts of catalyst were selected such that, for the same target hardness, i.e. the same ratio of butanediol to NCO prepolymer, equal casting times were obtained.

Remarks for table 2:

7: The cast elements were inhomogeneous and streaky irrespective of the amount of catalyst. The hardness was 3-5 Shore A units lower. The hardness varied with the layer thickness.

8: The cast elements were inhomogeneous and streaky irrespective of the amount of catalyst. The hardness was 3-5 Shore A units lower. The hardness varied with the layer thickness.

9: The two catalysts were not storage-stable in the polyol. The demolding time was uneconomically long.

10: The two catalysts were not storage-stable in the polyol. The specimens exhibited hard segment precipitation.

11: The two catalysts were storage-stable in the polyol only after addition of Baylith®. The demolding time was uneconomically long.

12: The two catalysts were storage-stable in the polyol after addition of Baylith. The specimens exhibited hard segment precipitation.

13: The demolding time was much longer than in the other examples 1 to 6 (about 30 min.), and inhomogeneous zones were found.

14: The hardness was 3-5 Shore A units lower than the samples of examples 3 and 6, produced with the same butanediol content.

15: The demolding time (>60 min.) was much longer than in examples 1 to 6 (about 30 min.), and inhomogeneous zones were found.

16: The hardness was 3-5 Shore A units lower than the samples of examples 3 and 6, produced with the same butanediol content.

Table 2 shows that it is not possible in any case to use the catalyst combinations used in these comparative examples to produce polyurethanes with the good properties as can be established with the inventive catalysts [examples 1 to 3 (table 1)]. In addition, the results for examples 1-3 also show that the casting times, compared to the comparative examples 4 to 6 (Thorcat® 535 catalysis), are the same or prolonged for otherwise the same formulation, which constitutes a great advantage.

1-17. (canceled)

18. A polyisocyanate polyaddition product with good mechanical properties, obtainable from
a) polyisocyanates and
b) NCO-reactive compounds from the group of bl) long-chain polyols having an OH number of 27 to 112 mg KOH/g and a functionality of 1.9 to 2.3 and b2) short-chain hydroxyl compounds having an OH number of 300 to 1810 mg KOH/g and a functionality of 1.9 to 2.3, in the presence of
c) latent catalysts
d) optionally further catalysts other than c) and/or activators with addition of
e) optionally fillers and/or fiber materials optionally assistants and/or additives, characterized in that the latent catalysts (c) used are mixtures of at least one metal catalyst from the group consisting of tin, titanium, zirconium, hafnium, bismuth, zinc, aluminum and iron catalysts and at least two blocked amines and/or amidines which switch at different temperatures, the onset temperature of one amine and/or amidine which switches at low switching temperature (T_{A}) being between 30° and 60° C. and the switching temperature of the other amine and/or amidine which switches at higher switching temperature (Tₘₐₓ) being between 80° C. and 150° C. and the difference between T_{A} and Tₘₐₓ being at least 20° C. and at most 100° C.

19. The polyisocyanate polyaddition product of claim 18, wherein the metal catalysts used are tin catalysts.

20. The polyisocyanate polyaddition product of claim 18, wherein the blocked amines used are salts and/or complexes of 1,8-diazabicyclo[5.4.0]undec-7-ene (DBU), of 1,4-diazabicyclo[2.2.2]octane (DABCO) and/or of 1,5-diazabicyclo[4.3.0]non-5-ene (DBN).

21. The polyisocyanate polyaddition product of claim 18, wherein the NCO-reactive compounds bl) used are polyester polyols.

22. The polyisocyanate polyaddition product of claim 18, wherein the short-chain hydroxyl compounds b2) are short-chain diols and/or triols and/or tetraols.

23. The polyisocyanate polyaddition product of claim 22, wherein the short-chain hydroxyl compounds b2) are 1,2-ethanediol, 1,2-propanediol, 1,3-propanediol, 1,4-butanediol, 1,5-pentanediol, 1,6-hexanediol.

24. The polyisocyanate polyaddition product of claim 18, wherein the polyisocyanates (a) are NCO prepolymers formed from diphenylmethane diisocyanate (MDI) and/or carbodiimidized/uretoniminized diphenylmethane diisocyanate and/or allophanatized MDI.

25. The polyisocyanate polyaddition product of claim 18, wherein the polyisocyanates (a) are NCO prepolymers based on polyester polyols.

26. A process for preparing the polyisocyanate polyaddition product of claim 18, comprising reacting the polyisocyanates (a) with the NCO-reactive compounds (b) in the presence of latent catalysts (c) and optionally additional catalysts other than (c) and/or activators, with addition of optionally fillers and/or fiber materials (e) and optionally assistants and/or additives (f), characterized in that the latent catalysts (c) used are mixtures of at least one metal catalyst from the group consisting of tin, titanium, zirconium, hafnium, bismuth, zinc, aluminum and iron catalysts and at least two blocked amines and/or amidines which switch at different temperatures, the onset temperature of one amine and/or amidine which switches at low switching temperature (TA) being between 30° and 60° C. and the switching temperature of the other amine and/or amidine which switches at higher switching temperature (Tmax) being between 80° C. and 150° C. and the difference between TA and Tmax being at least 20° C. and at most 100° C.

27. The process of claim 26, wherein the blocked amines and/or amidines are added via the NCO-reactive compounds b) and the metal catalyst separately.

28. The process of claim 26, wherein the blocked amines and/or amidines and the metal catalyst are added via the NCO-reactive compounds b).

29. The process of claim 26, wherein the blocked amines and/or amidines and a portion of the metal catalyst are added via the NCO-reactive compounds b) and the rest of the metal catalyst separately.

30. A latent catalyst consisting of mixtures of at least one metal catalyst from the group consisting of tin, titanium, zirconium, hafnium, bismuth, zinc, aluminum and iron catalysts and at least two blocked amines and/or amidines which switch at different temperatures, the onset temperature of one amine and/or amidine which switches at low switching temperature (TA) being between 30° and 60° C. and the switching temperature of the other amine and/or amidine which switches at higher switching temperature (Tmax) being between 80° C. and 150° C. and the difference between TA and Tmax being at least 20° C. and at most 100° C.
